(19) United States
(12) Patent Application Publication
(10) Pub. No.: US 2014/0370416 A1
(43) Pub. Date: Dec. 18, 2014

(54) PROTON EXCHANGE MEMBRANE FUEL CELL

(71) Applicant: The University of Leeds, Leeds Yorkshire (GB)

(72) Inventors: Nahla Eid Alhazmi, Leeds Yorkshire (GB); Derek Binns Ingham, Leeds Yorkshire (GB); Mohamad Saeed Ismail, Leeds Yorkshire (GB); Kevin James Hughes, Leeds Yorkshire (GB); Lin Ma, Leeds Yorkshire (GB); Mohamed Poukashanian, Leeds Yorkshire (GB)

(21) Appl. No.: 14/365,124

(22) PCT Filed: Dec. 7, 2012
(86) PCT No.: PCT/GB2012/053050

§ 371 Date: Jun. 13, 2014

(30) Foreign Application Priority Data
Dec. 13, 2011 (GB) 1121394.9
Dec. 7, 2012 (WO) PCTGB2012053050

(51) Int. Cl. H01M 8/04; G06F 17/50

(52) U.S. Cl. CPC H01M 8/04007; G06F 17/5009; H01M 2008/1095
USPC 429/492; 703/2

(57) ABSTRACT

The invention relates to a proton exchange membrane fuel cell and a method of designing the same. A method of designing a proton exchange membrane fuel cell comprising a gas diffusion layer is described. The method comprises: using a model of the proton exchange membrane fuel cell to determine performance of the fuel cell, wherein the model is based on a plurality of parameters of the fuel cell, the plurality of parameters including at least one anisotropic property of the gas diffusion layer, adjusting at least one of the plurality of parameters; determining whether or not performance of the fuel cell is improved by the adjusting step and designing the fuel cell by selecting the parameters which provide improved performance. A proton exchange membrane fuel cell is also described comprising a gas diffusion layer, the proton exchange membrane fuel cell having a plurality of parameters, wherein the parameters are selected to provide substantially uniform temperature distribution across the gas diffusion layer.

### FIELD OF THE INVENTION

The invention relates to a proton exchange membrane fuel cell and a method of designing the same.

### BACKGROUND TO THE INVENTION

Proton exchange membrane (PEM) fuel cells have a rapid start-up due to their low operating temperatures, which make them suitable for portable applications. One of the most important issues that should be taken into account when operating PEM fuel cells is the heat management to keep the temperature distribution within the fuel cell components as uniform as possible, otherwise the fuel cell may experience a thermal failure due to dehydration of the membrane. This requires an investigation into the effective thermal conductivity, an important component being the thermal conductivity of the porous media, which has anisotropic properties.

Recently, researchers have shown an increased interest in the effect of the anisotropic properties of GDLs on the performance of PEM fuel cells [1-5]. Khandelwal and Mench [6] reported that the through-plane thermal conductivity of SIGRACET to be 0.22±0.04 W/(m·K), whereas Toray reported it to be 1.8±0.27 W/(m·K). Ramousse et al. [7] reported the through-plane thermal conductivity of the GDL under different pressures, obtaining values of about 0.2 and 0.27 W/(m·K) under pressures of 4.6 and 13.9 bar respectively. However, Karimi [8] found the through-plane thermal conductivity to be 0.2 to 0.7 W/(m·K) under pressures of 0.7 and 13.8 bar. It is clear from these results that the thermal conductivity of the GDLs has differed significantly from one GDL to another. Many numerical investigations have been performed to investigate the effect of the thermal conductivity of the GDL. However, most PEM fuel cell models assume that the GDLs are comprised of an isotropic material.

Pharaoah and Burheim [9] developed two-dimensional models to investigate the temperature distribution in PEM fuel cells. The effect of the thermal conductivity of the GDL and the change in the water phase leads to higher temperatures in the cathode side than in the anode side. Zamel et al. [10] numerically estimated the in-plane and through-plane thermal conductivity of carbon paper, which is typically used as a gas diffusion layer in PEM fuel cells. The thermal conductivity of the GDL was sensitive to the porosity of the carbon paper. The thermal conductivity of the carbon paper was found to increase with a decrease in the porosity of the carbon paper, and the in-plane thermal conductivity was much higher than the through-plane thermal conductivity of the carbon paper. Burlatsky et al. [11] developed a mathematical model to investigate the scenario of water removal in PEM fuel cells. The water transport was dependent on the thermal conductivity of GDL and the water diffusion coefficients. He et al. [12] investigated the effect of the thermal conductivity of the GDL on the temperature distribution in PEM fuel cells. Their results indicated that the anisotropic thermal conductivity of the GDL results in higher temperature gradients than for an isotropic GDL, which led to a decrease in the water saturation in the anisotropic case. According to Ju Hyunchul [24], the temperature differences in PEM fuel cells were higher when using anisotropic GDL than the isotropic GDL. Furthermore, the isotropic GDLs achieved a uniform current density better than anisotropic gas diffusion layers.

However, so far, no researchers have validated their model results with experimental data.

U.S. Pat. No. 7,785,748 B2 of University of Delaware discloses novel methods for producing a nano-porous gas diffusion media, compositions thereof and devices comprising the same. A porous metallic gas diffusion layer is disclosed. The nano-porous diffusion media of this disclosure are said to display superior electro- and thermal conductivity.

### STATEMENTS OF THE INVENTION

According to a first aspect of the invention, there is provided a method of designing a proton exchange membrane fuel cell comprising a gas diffusion layer, the method comprising:
using a model of the proton exchange membrane fuel cell to determine performance of said fuel cell, wherein said model is based on a plurality of parameters of the fuel cell, said plurality of parameters including at least one anisotropic property of the gas diffusion layer,
adjusting at least one of the plurality of parameters;
determining whether or not performance of the fuel cell is improved by said adjusting step and
designing said fuel cell by selecting said parameters which provide improved performance.

Using said model to determine performance may comprise determining one or more of temperature distribution, water saturation, and/or current density of the fuel cell. The performance may be improved by providing a more uniform temperature distribution across the gas diffusion layer. The performance may be improved by maximising the water saturation of the fuel cell, e.g. at an interface between the gas diffusion layer and a catalyst layer.

Said fuel cell preferably comprises an anode and a cathode connected by a membrane. The model may comprise multiple zones defined within the fuel cell. Said multiple zones may comprise one or more of a current collector, a channel, a gas diffusion layer, a catalyst layer and said membrane. Separate zones may be defined for each of said anode and said cathode. Each of said zones may be subdivided into a plurality of cells whereby calculation time may be improved.

The method may further comprise making a fuel cell to said design whereby said results may be validated with the experimental data.

The plurality of parameters may include the material of the gas diffusion layer (GDL). For example, a conventional carbon-fibre-based GDL may be replaced with a metal-based GDL whose thermal and electrical conductivities are significantly higher than that of the conventional one. As an example, the thermal conductivity of copper and aluminium are about 400 and 240 W/(m·K) respectively.

The anisotropic properties may include one or more of the electrical conductivity, thermal conductivity, and/or permeability of the gas diffusion layer. Including such properties should enhance the prediction of the numerical model.

The thermal conductivity may include the in-plane thermal conductivity and/or the through plane thermal conductivity. The in-plane thermal conductivity may be adjusted to be at least 1 W(m·K), at least 10 W(m·K), at least 20 W(m·K) or at least 100 W(m·K). Whilst the in-plane thermal conductivity is being adjusted, the through plane thermal conductivity may be held constant, e.g. at 1 W(m·K). The through-plane thermal conductivity may be adjusted to be at least 0.1 W(m·K), at least 1 W(m·K), or at least 10 W(m·K). Whilst the through-plane thermal conductivity is being adjusted, the in-plane thermal conductivity may be held constant, e.g. at 10 W(m·K). The ratio of in-plane thermal conductivity to through plane thermal conductivity may be 10:1.

Adjusting the in-plane and through plane thermal conductivities separately allows the model to take account of the anisotropic thermal conductivity of the gas diffusion layer. A similar method could be applied to the electrical conductivity and/or permeability.

It is noted that as the thermal conductivity of the GDL increases, the rate of heat dissipation increases and therefore the temperature distribution become more uniform and the maximum temperature decreases. The heat is mainly generated as a result of exothermic electrochemical reaction taking place at the catalyst layer.

According to another aspect of the invention, there is provided a proton exchange membrane fuel cell comprising a gas diffusion layer, said proton exchange membrane fuel cell having a plurality of parameters, wherein said parameters are selected to provide substantially uniform temperature distribution across said gas diffusion layer.

The parameters may include the thermal conductivity of the gas diffusion layer. The thermal conductivity may comprise in-plane thermal conductivity and/or through-plane thermal conductivity of the gas diffusion layer is substantially isotropic.

The gas diffusion layer may have an in-plane thermal conductivity of at least 10 W/(m·K) or at least 100 W/(m·K). The through-plane thermal conductivity of the gas diffusion layer may be at least 1 W/(m·K) or at least 10 W/(m·K). The gas diffusion layer may have an in-plane thermal conductivity of at least 10 W/(m·K) and a through-plane thermal conductivity of at least 1 W/(m·K).

According to another aspect of the invention, there is provided a fuel cell comprising a proton exchange membrane having a gas diffusion layer, wherein the thermal conductivity of the gas diffusion layer is substantially isotropic.

According to another aspect of the invention, there is provided a fuel cell comprising a proton exchange membrane having a gas diffusion layer, wherein the in-plane thermal conductivity of the gas diffusion layer is substantially isotropic.

According to another aspect of the invention, there is provided a fuel cell comprising a proton exchange membrane having a gas diffusion layer, wherein the through-plane thermal conductivity of the gas diffusion layer is substantially isotropic.

According to another aspect of the invention, there is provided a fuel cell comprising a proton exchange membrane having a gas diffusion layer, wherein the gas diffusion layer has an in-plane thermal conductivity of at least 10 W/(m·K).

The in-plane thermal conductivity of the gas diffusion layer may be at least 100 W/(m·K), or at least 200 W(m·K) or at least 400 W(m·K).

The in-plane thermal conductivity of the gas diffusion layer may at least 1 W/(m·K) or at least 10 W/(m·K).

According to another aspect of the invention, there is provided a fuel cell comprising a proton exchange membrane having a gas diffusion layer, wherein the gas diffusion layer has an in-plane thermal conductivity of at least 10 W/(m·K) and a through-plane thermal conductivity of at least 1 W/(m·K).

The gas diffusion layer may be metallic.

According to another aspect of the invention, there is provided a fuel cell proton exchange membrane having a gas diffusion layer. According to another aspect of the invention, there is provided a fuel cell proton exchange membrane gas diffusion layer.

According to another aspect of the invention, there is provided a method of making a fuel cell comprising a proton exchange membrane having a gas diffusion layer, comprising the step of arranging the thermal conductivity of the gas diffusion layer in the in-plane and/or through-plane directions to be substantially isotropic.

The invention further provides processor control code to implement the above-described systems and methods, for example on a general purpose computer system or on a digital signal processor (DSP). The code is provided on a physical data carrier such as a disk, CD- or DVD-ROM, programmed memory such as non-volatile memory (eg Flash) or read-only memory (Firmware). Code (and/or data) to implement embodiments of the invention may comprise source, object or executable code in a conventional programming language (interpreted or compiled) such as C, or assembly code. As the skilled person will appreciate such code and/or data may be distributed between a plurality of coupled components in communication with one another.

### BRIEF DESCRIPTION OF THE DRAWINGS

The invention is diagrammatically illustrated, by way of example, in the accompanying drawings, in which:

FIG. 1 is a schematic representation of a PEM fuel cell within its computational domain;

FIG. 2 shows the polarisation curves, i.e. the variation of voltage with current density, for three theoretic fuel cells each having different in-plane thermal conductivities compared with experimental data;

FIG. 3 is a graph showing the variation in power density at four temperatures for the three different fuel cells of FIG. 2;

FIGS. 4a to 4c show the variation in temperature (K) distribution within the cathode GDL for the three different fuel cells;

FIGS. 5a to 5c shows the variation in water saturation at the interface between the cathode GDL and the cathode catalyst layer for the three different fuel cells;

FIG. 6 shows the polarisation curves, i.e. the variation of voltage with current density, for three theoretic fuel cells each having different through-plane thermal conductivities compared with experimental data;

FIG. 7 is a graph showing the variation in power density for the three different fuel cells of FIG. 6 at four temperatures;

FIGS. 8a to 8c show the variation in temperature (K) distribution within the cathode GDL for the three different fuel cells of FIG. 6;

FIGS. 9a to 9c show the variation in water saturation at the interface between the cathode GDL and the cathode catalyst layer for the three different fuel cells of FIG. 6;

FIGS. 10a to 10c show the variation in temperature (K) distribution within the PEM fuel cells for three theoretic fuel cells each having different in-plane thermal conductivities; and

FIG. 11 shows the polarisation curves, i.e. the variation of voltage with current density, for the three fuel cells of FIG. 10a compared with experimental data.

### DETAILED DESCRIPTION OF THE DRAWINGS

Gas diffusion layers (GDLs) are one of the main components in proton exchange membrane (PEM) fuel cells. Proton exchange membrane (PEM) fuel cells are the most popular type of fuel cell due to their high efficiency, quick start-up and low operating temperature. In order to obtain effective thermal and water management in PEM fuel cells, the thermal conductivity of the porous media should be determined. In addition, the thermal conductivity of the gas diffusion layers (GDLs) has anisotropic properties such as electrical conductivity and permeability. However, most PEM fuel cell models assume that the GDLs comprise isotropic material.

As described in more detail below, the effect of anisotropic thermal conductivity of the GDL is numerically investigated under different operating temperatures. It is found that the output of the numerical model with realistic thermal conductivity values is in good agreement with the experimental data. Furthermore, the sensitivity of the PEM fuel cell performance to the thermal conductivity of the GDL is investigated for both in-plane and through-plane directions and the temperature distributions between the different GDL thermal conductivities are compared. The results show that increasing the in-plane and through-plane thermal conductivity of the GDL increases the power density of PEM fuel cells significantly. Moreover, the temperature gradients show a greater sensitivity to the in-plane thermal conductivity of the GDL as opposed to the through-plane thermal conductivity. In summary, the effects of anisotropic GDLs on temperature distribution, and current density were assessed and the results were validated with experimental data.

In this study, a three-dimensional (3-D) multiphase model was developed with the following assumptions:
the fluid flow was assumed to be laminar, as the inlet velocity was low;
the reactions were under steady state conditions; and
the reaction gases were assumed to be ideal gases.

### Governing Equations

Basically, the fluid flow in the fuel cell is governed by the following equations [13]:

### Conservation of Mass:

∇·(ερ\vec{u})=0

∇·(ερ\vec{u})=0 (1)

### Conservation of Momentum:

$$∇ ( ɛ ρ \vec{u} \vec{u} ) = - ɛ ∇ p + ∇ \cdot ( μ ∇ ɛ \vec{u} ) + \frac{ɛ μ}{K} \\ ∇ \cdot ( ɛ ρ \vec{u} \vec{u} ) = ( ɛ ∇ ρ + ∇ ρ ) \qquad ( 2 )$$

### Conservation of Species:

∇·(ερ\vec{u}Yₖ)=∇·(ρDₖ^{eff}∇Yₖ)+Sₖ (3)

where ρ is the fluid density, \vec{u} is the fluid velocity vector, p is the fluid pressure, μ is the mixture viscosity, Yₖ is the mass fraction for gas species k, ε is the porosity of the porous media, Sₖ is the source or sink term for species k, and Dₖ^{eff} is the diffusion coefficient of species k and it can be calculated as follow:

Dₖ^{eff}=ε^{ξ}Dₖ (4)

where is the ξ of the porous media and D is the ordinary diffusion coefficient.

### Conservation of Charge:

$$\begin{matrix}∇ \cdot ( {σ}_{sol} ∇ {∅}_{sol} ) = \{ \begin{matrix}- {J}_{a} \\ - {J}_{c}\end{matrix} & ( 5 ) \\ ∇ \cdot ( {σ}_{mem} ∇ {∅}_{mem} ) = \{ \begin{matrix}{J}_{a} \\ {J}_{c}\end{matrix} & ( 6 )\end{matrix}$$

where σₛₒₗ is the electric conductivity of solid, σₘₑₘ is the proton conductivity in membrane, φₛₒₗ is the potential of solid phase, φₘₑₘ is the potential of membrane phase, Jₐ is cathode catalyst reaction rate and J_{c} is cathode catalyst reaction rate.

### Conservation of Liquid Water Formation:

∇·(ρ_{L}V_{L}S)=r_{w} (7)

where S is the liquid water saturation, L is the liquid water and r_{w} is the mass transfer rate between the gas and liquid.

### Conservation of Energy:

(ρcₚ)_{eff}(v·∇T)=∇·(k_{eff}∇T)+Sₑ (8)

where cₚ is the specific heat capacity of the gas mixture, T is the temperature, Sₑ is the energy source term and k_{eff} is the effective thermal conductivity of the gas mixture which is defined as the follows:

$${k}_{eff} = 2 {k}_{s} + {( \frac{ɛ}{2 {k}_{s} + {k}_{F}} + \frac{1 - ɛ}{3 {k}_{s}} )}^{- 1} \qquad ( 9 )$$

where kₛ and k_{F} are the thermal conductivities of the solid and fluid regions, respectively.

All the source terms in the above equations are listed in Table 1.

| Source terms | Defining equation |
|---|---|
| Species volumetric source terms | $\begin{matrix}{S}_{{H}_{2}} = - \frac{{M}_{W , {H}_{2}}}{2. F} \\ {S}_{{O}_{2}} = - \frac{{M}_{W , {O}_{2}}}{4. F} \\ {S}_{{H}_{2} O} = - \frac{{M}_{W , {H}_{2} O}}{2. F}\end{matrix}$ |
| Energy | ${S}_{e} = {h}_{react} - {R}_{an , cat} {η}_{an , cat} + {I}^{2} {R}_{ohm} + {h}_{l}$ |
| source term | |
| Cathode catalyst reaction rate | ${J}_{c} = {J}_{c}^{ref} ( \frac{{Y}_{{O}_{2}}}{{Y}_{{O}_{2}}^{ref}} ) [ exp ( \frac{- {α}_{a}}{RT} ( {φ}_{mem} - {φ}_{sol} - {V}_{OC} ) - exp ( \frac{- {α}_{c}}{RT} ( {φ}_{mem} - {φ}_{sol} - {V}_{OC} ) ) ]$ |
| Anode catalyst reaction rate | ${J}_{a} = {J}_{a}^{ref} ( \frac{{Y}_{{H}_{2}}}{{Y}_{{H}_{2}}^{ref}} ) [ exp ( \frac{{α}_{c}}{RT} ( {φ}_{sol} - {φ}_{mem} ) ) - exp ( \frac{{α}_{c}}{RT} ( {φ}_{sol} - {φ}_{mem} ) ) ]$ |
| Mass transfer | ${r}_{w} = {I}^{2} {R}_{ohm} + {η}_{an , cat} {J}_{an , cat} + {r}_{w} {h}_{L}$ |
| rate between | |
| gas and liquid | |

### Computational Domain

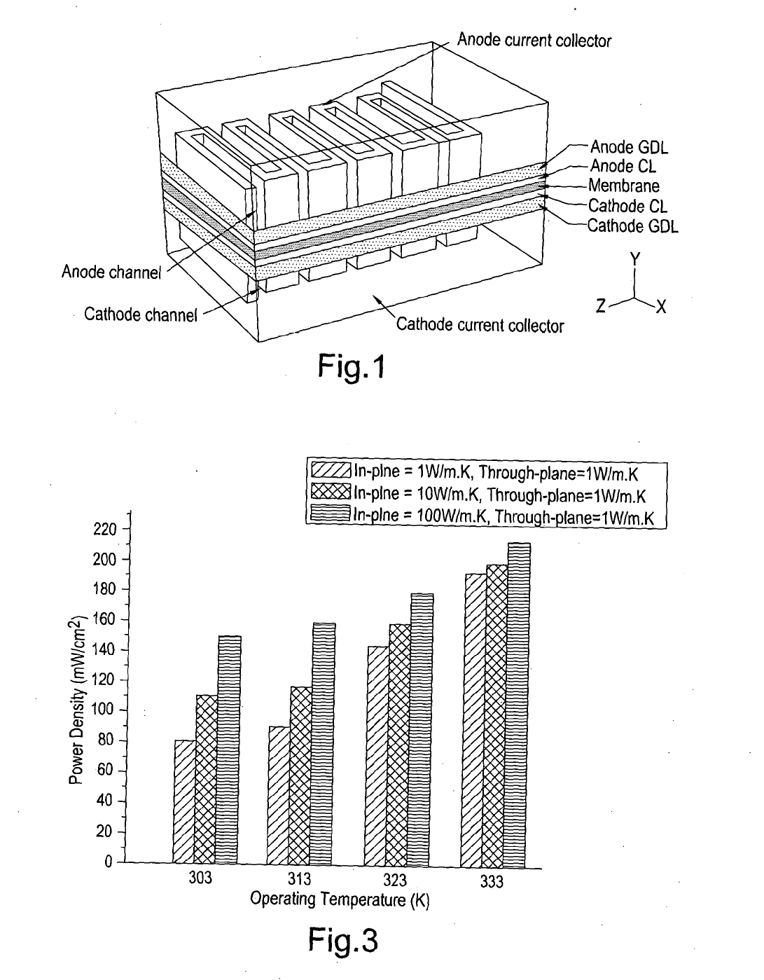

A schematic of the 11-channel serpentine flow field of the PEM fuel cell is shown in FIG. 1. Typically, a PEM fuel cell comprises a proton-conducting polymer membrane, (the electrolyte) which separates the anode and cathode sides. On the anode side, hydrogen diffuses to the anode catalyst where it later dissociates into protons and electrons. These protons often react with oxidants causing them to become what is commonly referred to as multi-facilitated proton membranes. The protons are conducted through the membrane to the cathode, but the electrons are forced to travel in an external circuit (supplying power) because the membrane is electrically insulating. On the cathode catalyst, oxygen molecules react with the electrons (which have traveled through the external circuit) and protons to form water—in this example, the only waste product, either liquid or vapor.

The different components of a PEMFC are bipolar plates, electrodes, catalyst, membrane, and the necessary hardwares. The materials used for different parts of the fuel cells differ by type. The bipolar plates may be made of different types of materials, such as, metal, coated metal, graphite, flexible graphite, C—C composite, carbon-polymer composites etc. The membrane electrode assembly (MEA) is usually made of a proton exchange membrane sandwiched between two catalyst coated carbon papers. Platinum and/or similar type of noble metals are usually used as the catalyst for PEMFC. The electrolyte could be a polymer membrane.

Merely as an example, the PEM fuel cell dimensions were specified as 32×10.81×32 mm in the x, y and z directions, respectively. The 3-D model consisted of nine zones which are: cathode current collector, cathode channel, cathode gas diffusion layer, cathode catalyst layer, membrane, anode catalyst layer, anode gas diffusion layer, anode channel, and anode current collector. 5 meshes were built with different numbers of cells and the average current density at 0.55 V was calculated for these 5 meshes. For the purposes of the example, a mesh which has about 1,800,000 control volumes is used to save calculation time and the computing memory to investigate the effect of the anisotropy thermal conductivity of the GDL on the performance of PEM fuel cell. This simulation has been performed by using the fuel cell module in the FLUENT® software.

### Physical and Operating Parameters

The fluid flow in the PEM fuel cell was generated under steady state conditions and all of the governing parameters, at the same values as the experimental parameters, are listed in Table 1. For the purposes of the examples, the velocity at the anode side was set to be 0.42 m/s with fully humidified hydrogen, while the velocity at the cathode channel was 1.06 m/s with humidified air. Isothermal constant temperature wall boundaries were defined for the cell sides and the current collectors. The operating temperatures were 303K, 313K, 323K, and 333K, respectively. The gauge pressure was set to be 2.5 bar at both the anode and cathode sides. All the physical, geometrical and operational parameters for the example are summarised in table 2 below:

| Parameter | Value | |
|---|---|---|
| Channel length (m) | 2.8 × 10⁻² | |
| Channel height (m) | 2.0 × 10⁻³ | |
| Channel width (m) | 2.0 × 10⁻³ | |
| GDL thickness (m) | 3.0 × 10⁻⁴ | |
| Catalyst layer thickness (m) | 3.0 × 10⁻⁵ | |
| Membrane thickness (m) | 1.5 × 10⁻⁴ | |
| Operating temperature (K) | 303 | |
| Gauge pressure at anode (bar) | 2.5 | |
| Gauge pressure at cathode (bar) | 2.5 | |
| Porosity of catalyst layer | 0.4 | [14] |
| Porosity of GDL | 0.7 | [15] |
| Through-plane permeability of | 4.97 × 10⁻¹³ [16] | |
| GDL (m²) | | |
| In-plane permeability of GDL (m²) | 1.87 × 10⁻¹² [16] | |
| Through-plane inertial coefficient | 4.22 × 10⁷ [16] | |
| of GDL (m⁻¹) | | |
| In-plane inertial coefficient of GDL | 4.05 × 10⁶ [16] | |
| (m⁻¹) | | |
| Through-plane electrical | 48 | [17] |
| conductivity of GDL (S/m) | | |
| In-plane electrical conductivity of | 4000 | [7] |
| GDL (S/m) | | |
| Permeability of catalyst layer (m2) | 1 × 10−13 [18] | |
| Electrical conductivity of catalyst | 300 | [19] |
| layers (S/m) | | |
| Permeability of membrane (m2) | 1.8 × 10−18 | |
| Density of current collectors | 1860 | |
| (kg/m3) | | |
| Specific heat capacity of current | 865 | |
| collectors (J/(kg · K)) | | |
| Electrical conductivity of current | 3200 | |
| collectors (S/m) | | |
| Anode inlet gas velocity (m/s) | 0.42 | |
| Cathode inlet gas velocity (m/s) | 1.06 | |
| Inlet mass fraction of hydrogen | 0.37 | |
| (Anode) | | |
| Inlet mass fraction of water | 0.63 | |
| (Anode) | | |
| Inlet mass fraction of oxygen | 0.22 | |
| (Cathode) | | |
| Inlet mass fraction of nitrogen | 0.72 | |
| (Cathode) | | |
| Inlet mass fraction of water | 0.06 | |
| (Cathode) | | |
| Transfer coefficients for cathode | 0.512 | [20] |
| reaction | | |
| Reference exchange current | 193 | [20] |
| density at cathode (A/m2) | | |
| Transfer coefficients for anode | 0.5 | [20] |
| reaction | | |
| Reference exchange current | 930000 | [20] |
| density at anode (A/m2) | | |

### Results and Discussion

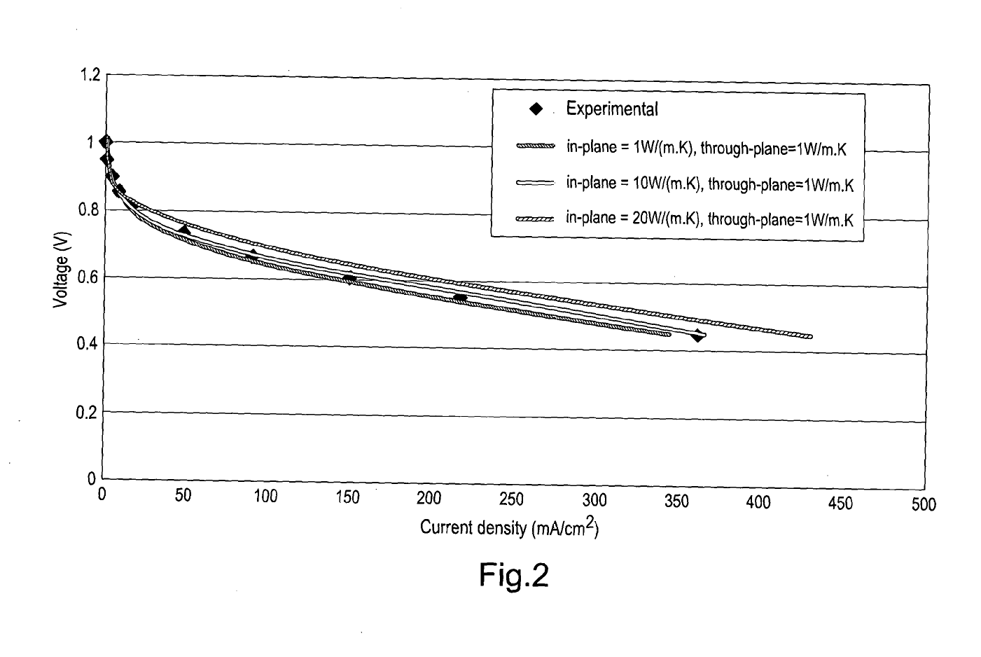

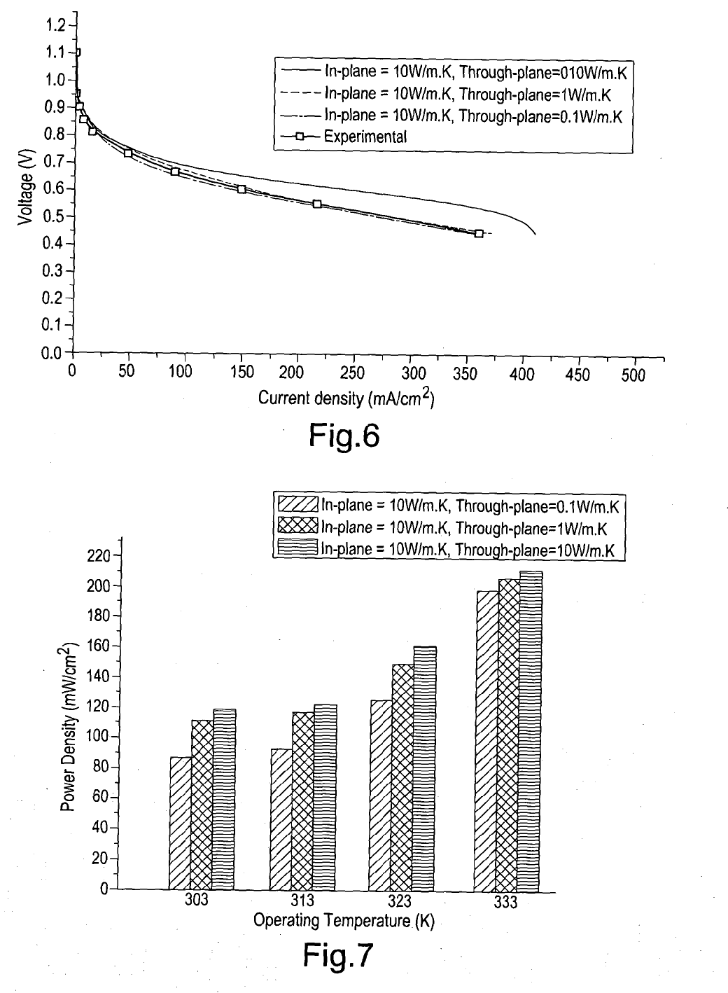

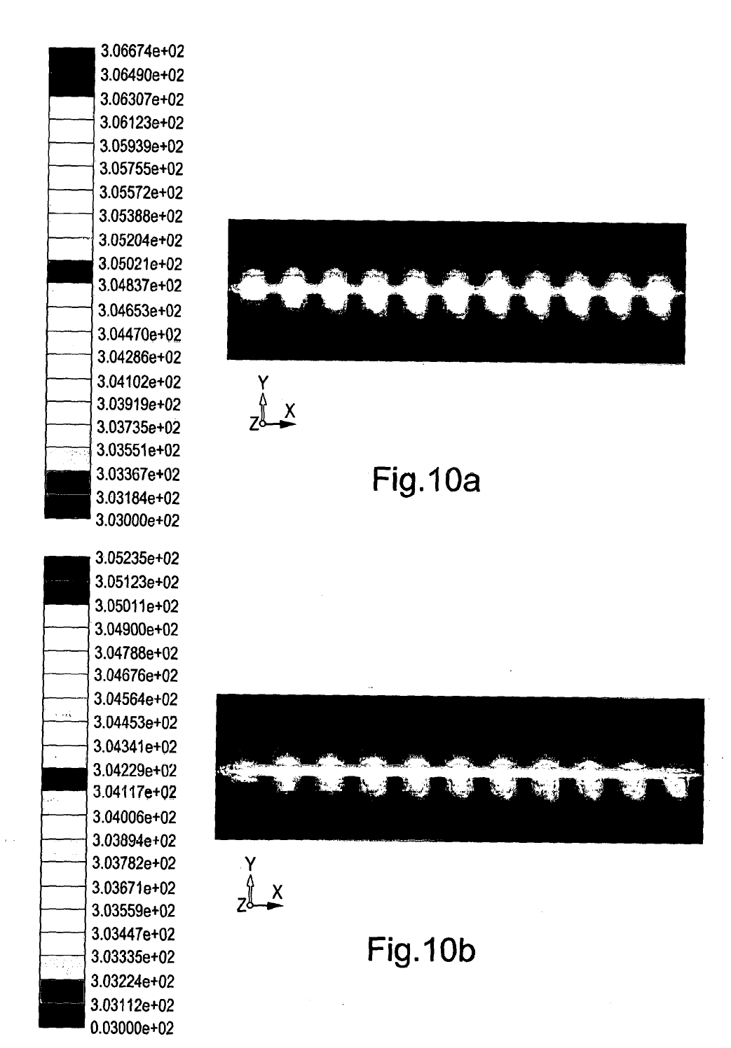

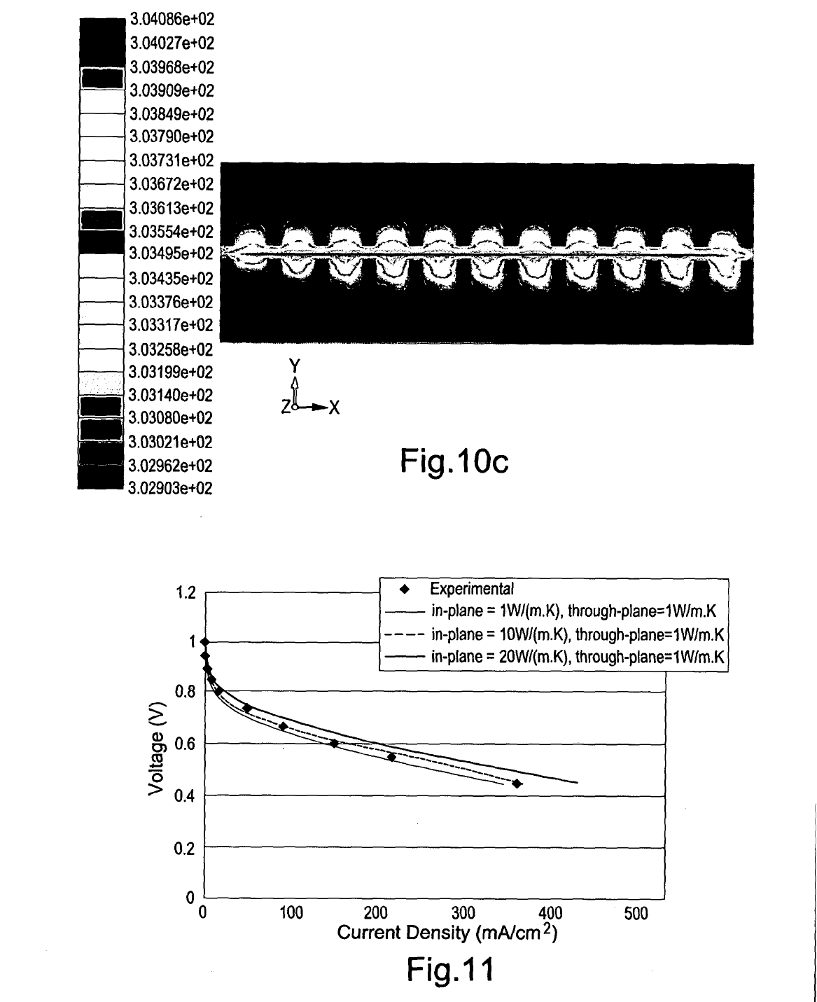

In order to investigate the effect of the anisotropic thermal conductivity of the GDL in PEM fuel cells, nine different cases were developed. The first three cases investigated the effect of the in-plane thermal conductivity and the results are shown in FIGS. 2 to 5c. The second three cases investigated the effect of the through-plane thermal conductivity and the results are shown in FIGS. 6 to 10c. The last three investigated the effect of the in-plane thermal conductivity and the results are shown in FIGS. 10a to 11.

The first three cases are summarised below:

| | Through-plane thermal | In-plane thermal |
|---|---|---|
| | conductivity of GDL | conductivity of GDL |
| Case Number | (W/(m · K)) | (W/(m · K)) |
| I | 1 | 1 |
| II | 1 | 10 |
| III | 1 | 100 |

In these first three examples, the in-plane thermal conductivity of the GDL was increased from 1 to 10 to 100 W/(m·K). The in-plane thermal conductivity has been reported to be between 10-15 W/(m·K) [10] and based on this it has been decided to increase and decrease this value by a factor of 10. The through-plane thermal conductivity of the GDL was retained at a constant value of 1 W/(m·K), namely the reported experimental value [6, 10].

FIG. 2 shows the polarisation curves which were generated for the different cases and compared with the experimental data for the in-house PEM fuel cell. We observe that the results show good agreement between the experimental data and the case II, where the in-plane thermal conductivity was 10 W/(m·K) and the through-plane thermal conductivity was 1 W/(m·K). As mentioned earlier, this is most likely to be the thermal conductivity values in the experimental investigations.

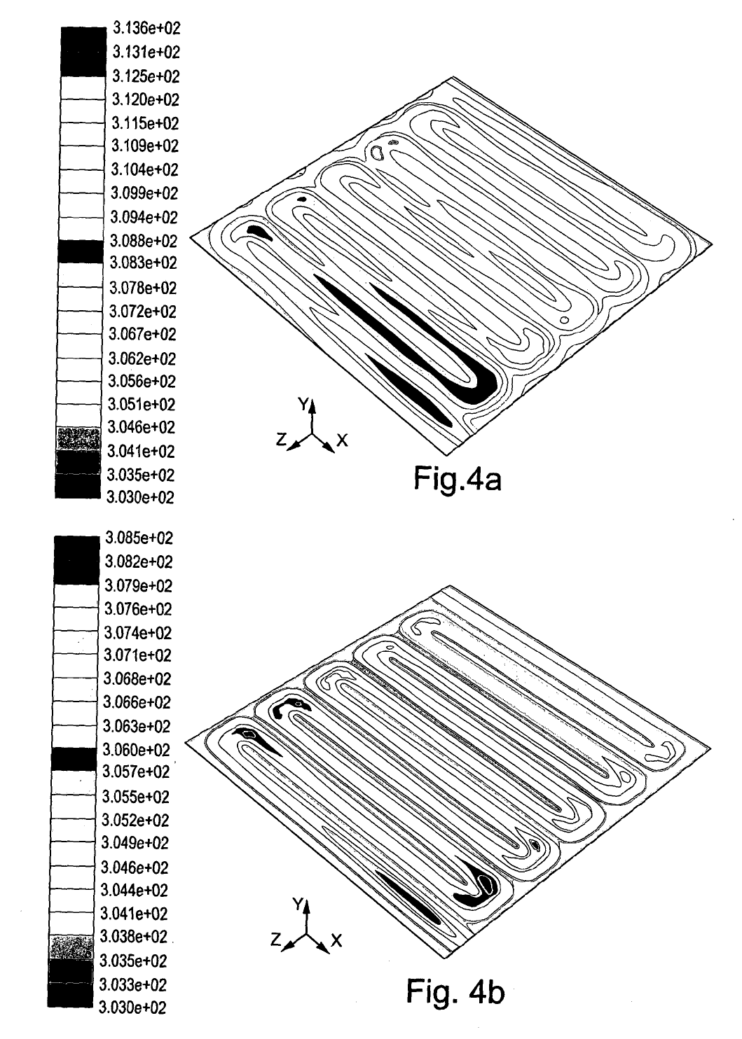

FIG. 3 illustrates the power density of the PEM fuel cell at 0.55 V, which is one of the normal operating voltages of PEM fuel cells. It is clear that as the in-plane thermal conductivity of the GDL increases from 1 to 10 to 100 W/(m·K), the power density of the PEM fuel cell increases from 84.2 to 109.5 to 152.1 mA/cm², respectively. A similar, though less pronounced effect was found at the higher operating temperatures of the PEM fuel cell of 313K, 323K and 333K.

The effect of the thermal conductivity of the GDL on the power density was because of the decrease in the electrical resistance when the temperature decreases as a result of increasing the thermal conductivity [21]. Furthermore, the increased overall thermal conduction of the GDL assists in dissipating the heat from the MEA and consequently these results in a more uniform temperature distribution and having more liquid water to humidify the membrane, which enhances the ionic conductivity, and subsequently improves the performance of the cell [22].

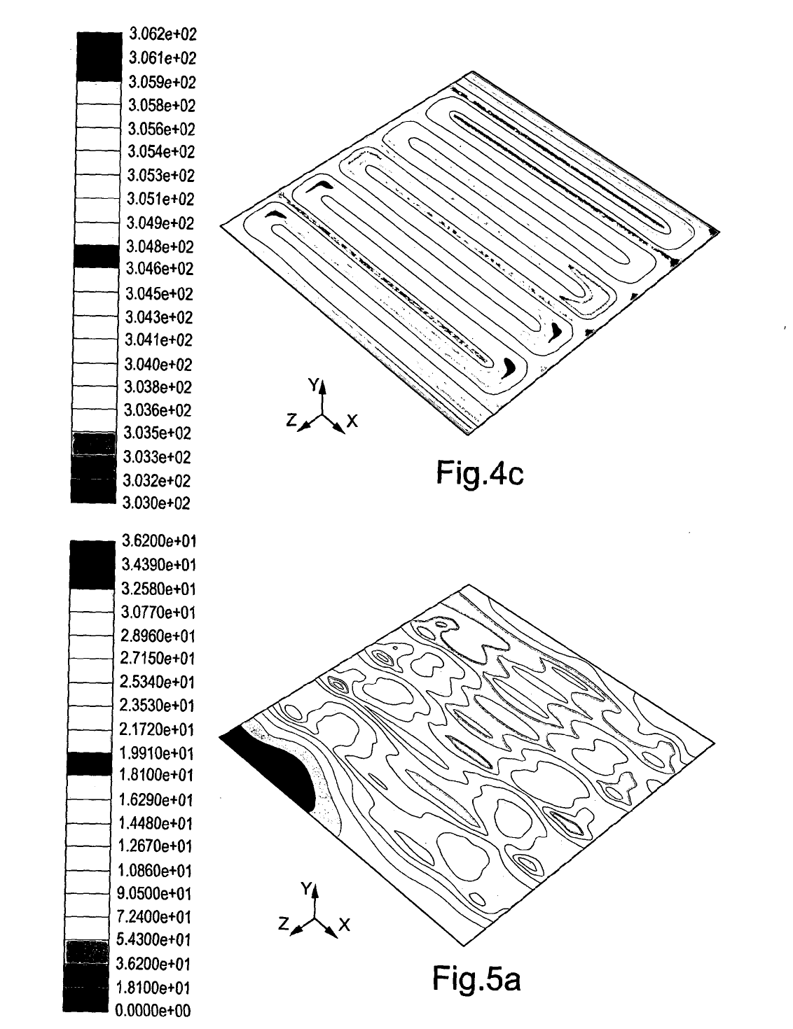

The temperature distribution through the GDL is presented in FIGS. 4a to 4c. The results show that as the in-plane thermal conductivity of the GDL increases, the difference in the temperatures decreases and the temperature in the GDL becomes more uniform. The maximum temperature was found to be 313.6K when the in-plane thermal conductivity of the GDL was 1 W/(m·K) and the difference in the temperatures was 10K. The maximum temperature decreases to 308.5K when the in-plane thermal conductivity of the GDL increases to 10 W/(m·K) and the difference in the temperatures was 5.5K. Finally, the maximum temperature became 306.1K when the in-plane thermal conductivity was 100 W/(m·K) and the temperature becomes more uniform along the GDL.

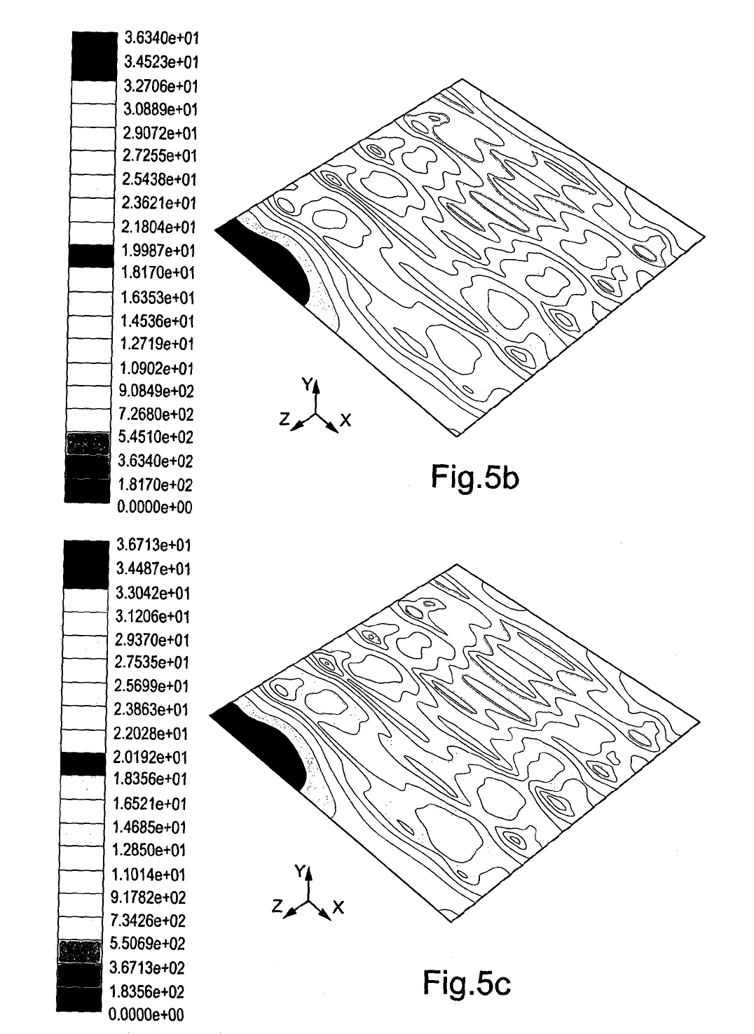

The low in-plane thermal conductivity causes regions of the fuel cell to remain relatively cold, thus increasing the likelihood of the formation of water pockets which may block the channels in the PEM fuel cell. This is illustrated in FIGS. 5a to 5c.

It can be seen from FIG. 5c that the maximum water saturation was 0.367 when the in-plane thermal conductivity was at its maximum value, namely 100 W/mk. This high water saturation means that more liquid water remains in the cathode because of the low temperature which is caused by the high in-plane thermal conductivity of the GDL [11, 21]. This leads to less water, which is produced by the electrochemical reactions in the cell, to vaporize than in the low in-plane thermal conductivity cases [23].

The second three cases are summarised below:

| | Through-plane thermal | In-plane thermal |
|---|---|---|
| | conductivity of GDL | conductivity of GDL |
| Case Number | (W/(m · K)) | (W/(m · K)) |
| IV | 0.1 | 10 |
| V | 1 | 10 |
| VI | 10 | 10 |

In these second three examples, the effect of the through-plane thermal conductivity was investigated. The through-plane thermal conductivity of the GDL increases from 0.1 to 1 to 10 W/(m·K), while the in-plane thermal conductivity of GDL was kept constant at 10 W/(m·K), the experimental value. The through-plane thermal conductivity was reported to be between 0.1-1 W/(m·K) [6, 10] and based on this it has been decided to increase and decrease this value by a factor of 10.

FIG. 6 shows the polarisation curves obtained from the CFD model compared with the experimental data for the in-house PEM fuel cell. The results show good agreement between the experimental data and case V, which is also Case II in Table 2.

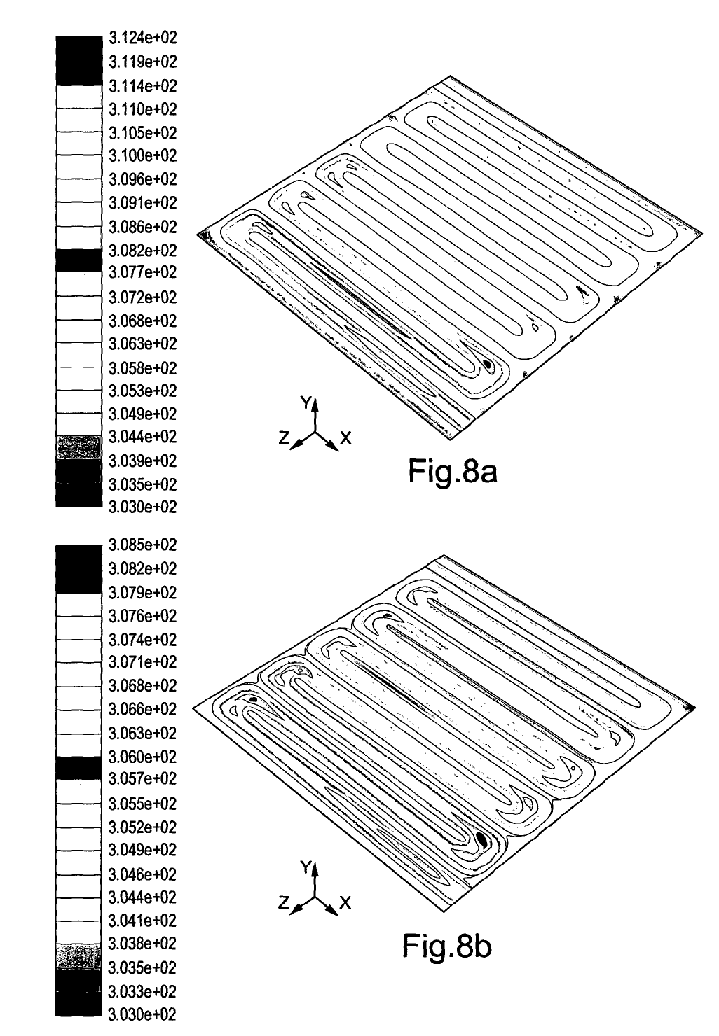

FIG. 7 illustrates the power density of the PEM fuel cell at 0.55 V, one of the typical operating voltages of PEM fuel cells. As the in-plane thermal conductivity of the GDL increases from 0.1 to 1 to 10 W/(m·K), the power density of the PEM fuel cell increases from 84.1 to 109.5 to 119.2 mA/cm2, respectively. This increasing behaviour is also observed at each temperature when the operating temperature of the PEM fuel cell increases from 313K to 323K to 333K. The increased through-plane thermal conductivity assists in decreasing the difference in the temperatures and subsequently less liquid water is evaporated and this improves the performance of the PEM fuel cell.

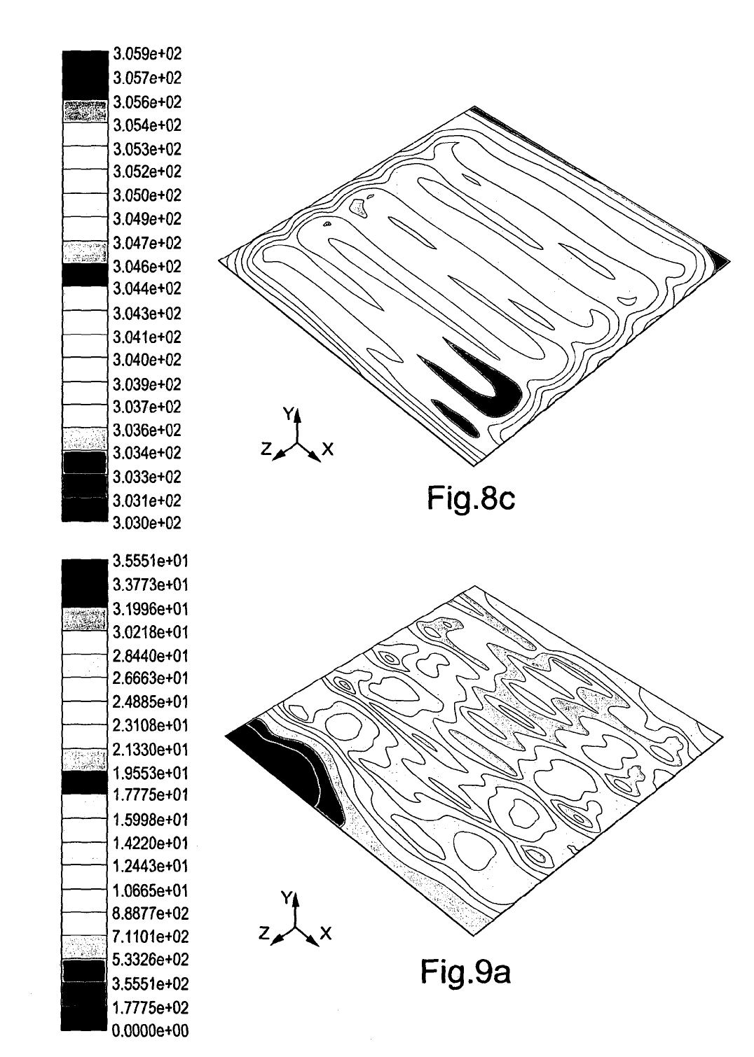

The effect of the through-plane thermal conductivities of the GDL on the temperature distribution in the PEM fuel cell is illustrated in FIGS. 8a to 8c. The maximum temperature was found to be 312.4K when the through-plane thermal conductivity of the GDL was 0.1 W/(m·K) and the maximum difference in the temperatures was 9.4K. The maximum temperature reduces to 308.5K when the through-plane thermal conductivity of the GDL increases to 1 W/(m·K) and the maximum difference in the temperatures was 5.5K. Finally, the maximum temperature became 305.9K when the in-plane thermal conductivity was 10 W/(m·K), the temperature became more uniform along the GDL, and the difference in the temperatures was no more than 2.9K. This is because the increase in the heat removal within the GDL assists in producing a more uniform temperature distribution[22].

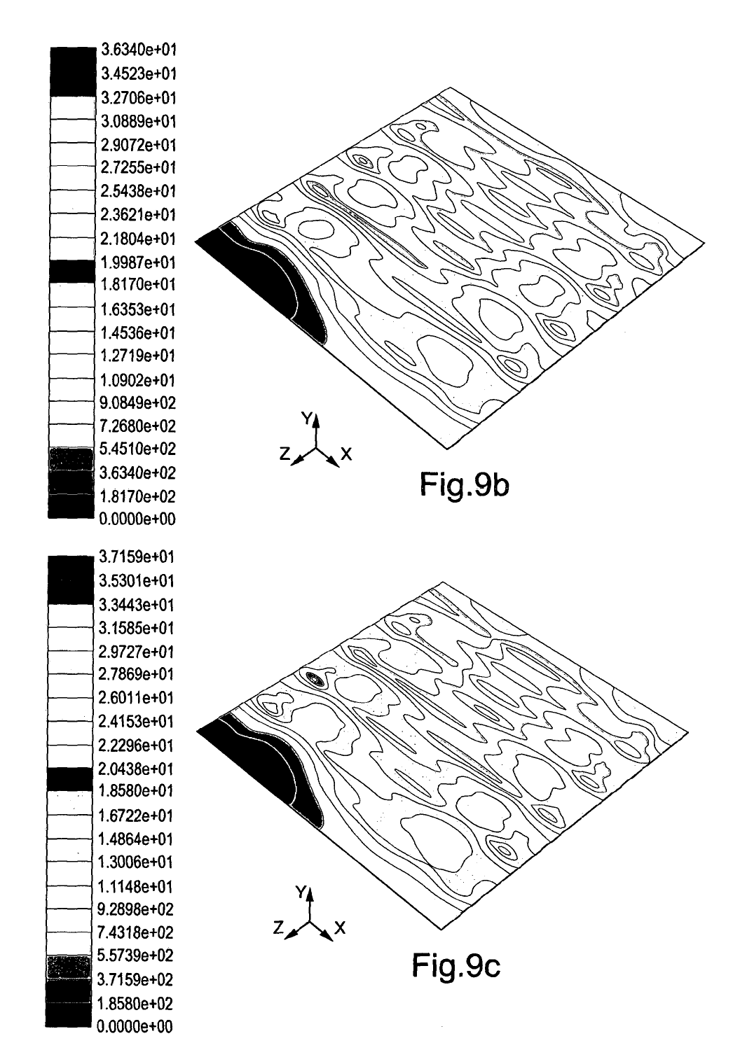

It can be seen from FIGS. 9a to 9c that the maximum water saturation was 0.371 when the through-plane thermal conductivity was a maximum, namely 10 W/(m·K). This high water saturation means that more liquid water remains in the cathode because of the low temperature which is caused by the high in-plane thermal conductivity of the GDL. This water saturation reduces to 0.355 when the through-plane thermal conductivity of the GDL was reduced to 0.1 W/(m·K).

Another three cases are summarised below:

| | Through-plane thermal | In-plane thermal |
|---|---|---|
| | conductivity of GDL | conductivity of GDL |
| Case Number | (W/(m · K)) | (W/(m · K)) |
| VII | 1 | 20 |
| VIII | 1 | 10 |
| IX | 1 | 1 |

In this study, as set out above, a three-dimensional (3-D) model was developed under steady state conditions. In this case; the velocity at the anode side was 0.24 m/s with fully humidified hydrogen, while the velocity at the cathode channel was 1.06 m/s with humidified air. The thermal wall boundaries were defined for the cell sides and the current collectors. The in-plane thermal conductivity of the GDL increased slightly, while the through-plane thermal conductivity of the GDL kept constant at 1 (W/(m·K).

As shown in FIGS. 10a to 10c, the temperature decreased when the in-plane thermal conductivity was increased, and the temperature was higher under the channel regions than in the current collector regions. The maximum temperatures were 306.6 K, 305.2K and 304.0 K for 1 (W/(m·K)), 10 (W/(m·K)) and 20 (W/(m·K)) in-plane thermal conductivity, respectively.

As shown in FIG. 11, the overall performance of the PEM fuel cell increased when the in-plane thermal conductivity of the GDL increased.

### Conclusions

A 3-D multiphase model has been developed to investigate the effect of the anisotropic thermal conductivity of the GDL on the performance of PEM fuel cells, and the results have been validated with an in-house PEM fuel cell. It has been found that the maximum temperature in the PEM fuel cell decreases when the thermal conductivity increases under the operating conditions investigated. In addition, the difference in the temperatures decreases when increasing the in-plane and through-plane thermal conductivities. The results show an increase in the current density of PEM fuel cells with an increase in the thermal conductivity of the GDL in both directions, namely the in-plane and the through-plane. This is the situation for all of the different operating temperatures that have been investigated (303K, 313K, 323K, and 333K). Moreover, increasing the thermal conductivity of the GDL increases the liquid water saturation as the maximum temperature decreases. This study has highlighted the need to accurately determine the thermal conductivity of the GDL.

### NOMENCLATURE

A Cross-sectional area of the MEA (m²)
F Faraday's constant
I Current density magnitude (A m⁻²)
i^{ref} Reference current density (A m⁻²)
J Reaction rate
K Thermal conductivity of the GDL (Wm⁻¹ K⁻¹)
M Molar mass (kg mol⁻¹)
R Universal gas constant (J mol⁻¹ K⁻¹)
Sₑ Energy source term
S_{H}_{₂} Hydrogen source term
S_{O}_{₂} Oxygen source term
S_{H}_{₂}_{O} Water source term
T Temperature (K)
V_{OC} Voltage (V)
Y Mass fraction

Greek Symbols:
φₘₑₘ Electrolyte phase potential (V)
φₛₒₗ Solid phase potential (V)
ε Porosity of the porous media
σₘₑₘ The proton conductivity in membrane
σₛₒₗ The electric conductivity of solid
μ Fluid viscosity (Pa·s)
ρ Density (kg/m³)

Subscripts:
an Anode
cat Cathode
H₂ Hydrogen
H₂o Water
L The liquid water
mem membrane
O₂ Oxygen
ref Reference

Abbreviations:
CFD Computational Fluid Dynamics
CL Catalyst Layer
GDL Gas Diffusion Layer
MEA Membrane Electrode Assembly
PEMFC Proton Exchange Membrane Fuel Cell

### REFERENCES

1. Barbir F., (2011) Pem Fuel Cells: Theory and Practice. Elsevier Science & Technology.
2. Hoogers G., (2003) Fuel cell technology handbook. CRC Press.
3. Blomen L. J., M. J. and Mugerwa M. N., (1993) Fuel cell systems. Plenum Press.
4. Larminie J. and Dicks A., (2000) Fuel cell systems explained. Wiley.
5. Basu S., (2006) Recent trends in fuel cell science and technology. Springer.
6. Khandelwal M. and Mench M., (2006) Direct measurement of through-plane thermal conductivity and contact resistance in fuel cell materials. Journal of Power Sources, 161, pp. 1106-1115.
7. Ramousse J., Lottin O., Didierjean S., Maillet D., (2009) Heat sources in proton exchange membrane (PEM) fuel cells. Journal of Power Sources, 192, pp. 435-41
8. Karimi G., Li X. and Teertstra P., (2010) Measurement of through-plane effective thermal conductivity and contact resistance in PEM fuel cell diffusion media. Electrochimica Acta 55, pp. 1619-1625.
9. Pharaoh J. G. and Burheim O. S., (2010) On the temperature distribution in polymer electrolyte fuel cells. Journal of Power Sources, 195, pp. 5235-5245.
10. Zamel N., Li x., Shen J., Wiegmann A., Becker J., (2010) Estimating effective thermal conductivity in carbon paper diffusion media. Chemical Engineering Science, 65, pp. 3994-4006.
11. Burlatsky S., Atrazhev V., Gummalla M., Liu F., (2009) The impact of thermal conductivity and diffusion rates on water vapor transport through gas diffusion layers. Journal of Power Sources, 190, pp. 485-492.
12. He G., Yamazaki Y. and Abudula A., (2010) A three-dimensional analysis of the effect of anisotropic gas diffusion layer (GDL) thermal conductivity on the heat transfer and two-phase behavior in a proton exchange membrane fuel cell (PEMFC). Journal of Power Sources, 195, pp. 1551-1560.
13. Ma L., Inghham D. B., Pourkashanian M., (2005) Review of the computational fluid dynamics modeling of fuel cells. Journal of Fuel Cell Science and Technology, 2, pp. 246-257.
14. Bernardi D. M. and M. W. Verbrugge, A Mathematical Model of the Solid Polymer Electrolyte Fuel Cell. Journal of the Electrochemical Society, 1992. 139(9): p. 2477-2491.
15. P. M. Wilde, M. M., M. Murata, and N. Berg, Structural and Physical Properties of GDL and GDL/BPP Combinations and their Influence on PEMFC Performance. Fuel Cells, 2004. 4(3): p. 180-184.
16. Ismail M. S., Damjanovicb T., Inghama D. B., Ma L., Pourkashaniana M., Effect of polytetrafluoroethylene-treatment and microporous layer-coating on the in-plane permeability of gas diffusion layers used in proton exchange membrane fuel cells. Journal of Power Sources, 2010. 195(19): p. 6619-6628.
17. Ismail M. S., by M S Ismail, T Damjanovic, D B Ingham, M Pourkashanian, A Westwood, Effect of polytetrafluoroethylene-treatment and microporous layer-coating on the electrical conductivity of gas diffusion layers used in proton exchange membrane fuel cells. Journal of Power Sources, 2010. 195(9): p. 2700-2708.
18. Kim, G.-S., Sui, P. C., Shah, A. A., Djilali, Ned, Reduced-dimensional models for straight-channel proton exchange membrane fuel cells. Journal of Power Sources. 195(10): p. 3240-3249.
19. Cheng C., H. Lin, and G J. Lai, Numerical prediction of the effect of catalyst layer Nafion loading on the performance of PEM fuel cells. Journal of Power Sources, 2007. 164(2): p. 730-741.
20. ANSAYS Fluent, “Fuel cell modueles manual,” Lebanon, N.H. (USA) Fluent Inc, 2010.
21. Tritt, T. M., Thermal conductivity: theory, properties, and applications. 2004: Kluwer Academic/Plenum Publishers.
22. Meng H., Numerical studies of liquid water behaviors in PEM fuel cell cathode considering transport across different porous layers. International Journal of Hydrogen Energy, 2010. 35: p. 5569-5579.
23. Gostick T., Ioannidis A., Pritzker D., and Fowler W., Impact of liquid water on reactant mass transfer in PEM fuel cell electrodes. Journal of the Electrochemical Society, 2010. 157: p. B563-B571.
24. Ju H., Investigation of the effects of the anisotropy of gas-diffusion layers on heat and water transport in polymer electrolyte fuel cells. Journal of Power Sources, 2009. 191(2): p. 259-268

No doubt many other effective alternatives will occur to the skilled person. It will be understood that the invention is not limited to the described embodiments and encompasses modifications apparent to those skilled in the art lying within the spirit and scope of the claims appended hereto.

1. A method of designing a proton exchange membrane fuel cell comprising a gas diffusion layer, the method comprising:
using a model of the proton exchange membrane fuel cell to determine performance of said fuel cell, wherein said model is based on a plurality of parameters of the fuel cell, said plurality of parameters including at least one anisotropic property of the gas diffusion layer,
adjusting at least one of the plurality of parameters;
determining whether or not performance of the fuel cell is improved by said adjusting step and
designing said fuel cell by selecting said parameters which provide improved performance.

2. The method according to claim 1 comprising using said model to determine performance by determining at least one of temperature distribution, water saturation, and current density of the fuel cell.

3. The method according to claim 2, wherein the performance is improved by providing a more uniform temperature distribution across the gas diffusion layer.

4. The method according to claim 1 wherein the model comprises multiple zones defined within the fuel cell.

5. The method according to claim 4, wherein said multiple zones comprise at least one of a current collector, a channel, a gas diffusion layer, a catalyst layer and said membrane.

6. The method according to claim 5, wherein the fuel cell comprises an anode and a cathode and wherein separate zones are defined for each of said anode and said cathode.

7. The method according to claim 1 comprising making a fuel cell to said design whereby said modelled performance is validated with the experimental data.

8. The method according to claim 1, wherein the plurality of parameters include the material of the gas diffusion layer (GDL).

9. The method according to claim 1, wherein the anisotropic properties include at least one of the electrical conductivity, thermal conductivity, and permeability of the gas diffusion layer.

10. The method according to claim 9, wherein the thermal conductivity includes in-plane thermal conductivity and through-plane thermal conductivity.

11. A proton exchange membrane fuel cell comprising a gas diffusion layer, said proton exchange membrane fuel cell having a plurality of parameters, wherein said parameters are selected to provide substantially uniform temperature distribution across said gas diffusion layer.

12. The fuel cell according to claim 11, wherein the parameters include thermal conductivity of the gas diffusion layer, and wherein the thermal conductivity includes at least one of in-plane thermal conductivity and through-plane thermal conductivity, and wherein at least one of the thermal conductivity, the in-plane thermal conductivity, and the through-plane thermal conductivity of the gas diffusion layer is substantially isotropic.

13. The fuel cell according to claim 12, wherein the gas diffusion layer has an in-plane thermal conductivity of at least 10 W/(m·K).

14. The fuel cell according to claim 11, wherein the gas diffusion layer has a through-plane thermal conductivity of the gas diffusion layer is at least 1 W/(m·K).

15. The fuel cell according to claim 11, wherein the gas diffusion layer has an in-plane thermal conductivity of at least 10 W/(m·K) and a through-plane thermal conductivity of at least 1 W/(m·K).

16. A fuel cell comprising a proton exchange membrane having a gas diffusion layer, wherein a thermal conductivity of the gas diffusion layer includes at least one of in-plane thermal conductivity and through-plane thermal conductivity, and wherein at least one of the thermal conductivity, the in-plane thermal conductivity, and the through-plane thermal conductivity of the gas diffusion layer is substantially isotropic.

17.-25. (canceled)

26. A fuel cell as claimed in claim 11, wherein the gas diffusion layer is metallic.

27.-29. (canceled)

30. The fuel cell according to claim 12, wherein the gas diffusion layer has an in-plane thermal conductivity of at least 100 W/(m·K).

31. The fuel cell as claimed in claim 16, wherein the in-plane thermal conductivity of the gas diffusion layer is at least 200 W/(m·K).

32. The fuel cell as claimed in claim 16, wherein the in-plane thermal conductivity of the gas diffusion layer is at least 400 W/(m·K).
